(19) United States
(12) Patent Application Publication
(10) Pub. No.: US 2023/0217492 A1
(43) Pub. Date: Jul. 6, 2023

(54) CHANNEL ACCESS FOR MULTI-LINK DEVICES

(71) Applicant: Nokia Technologies Oy, Espoo (FI)

(72) Inventors: Adrian GARCIA RODRIGUEZ, Santa Cruz de Tenerife (ES); Nuno Manuel KIILERICH PRATAS, Gistrup (DK); Olli ALANEN, Vantaa (FI); Claudio ROSA, Randers NV (DK); Mika KASSLIN, Espoo (FI); Lorenzo GALATI GIORDANO, Stuttgart (DE)

(21) Appl. No.: 17/998,982

(22) PCT Filed: Mar. 24, 2021
(86) PCT No.: PCT/EP2021/057507

§ 371 Date: Nov. 16, 2022

Related U.S. Application Data
(60) Provisional application No. 63/027,034, filed on May 19, 2020.

(51) Int. Cl. H04W 74/08

(52) U.S. Cl. CPC H04W 74/0816

(57) ABSTRACT

According to an example aspect of the present invention, there is provided a method, comprising: occupying a first channel for data transmission between a first multi-link device (MLD) and a second MLD for a first channel occupation period (COP), transmitting a measurement request to a subset of MLDs to perform channel measurements on at least two channels during the first COP, transmitting at least one data message to the second MLD during the first COP, receiving, after transmission of the at least one data message, at least one channel status report comprising channel status information from at least one MLD of the subset of MLDs during the first COP, and selecting a channel, among the at least two channels, for data transmission between the first MLD and an MLD for a second COP, wherein the selection is based at least partly on the channel status report.

### FIELD

Various example embodiments relate to arranging channel access for wireless communications, particularly for multi-link devices.

### BACKGROUND

Wireless medium channel utilization may be based on sharing many frequencies in many wireless networks, such as wireless local area networks (WLANs). In case of shared channels, users tune on the same channel to transmit data. An unlicensed channel may be shared also by networks of different radio access technologies (RATs). To avoid collisions, several access techniques exist, such as the carrier sense multiple access with collision avoidance (CSMA-CA).

A plurality of wireless communication channels can be used across a number of wireless networks, wherein one network overlaps one or more other networks. A multi-link capable device may be capable of communicating with another wireless device over a radio connection comprising multiple radio links. The multi-link device may dynamically change from one channel to another. Operating on multiple links concurrently may improve throughput and/or reduce channel access delays.

For example, collisions can occur when one basic service set (BSS) of WLANs occupies a channel of another BSS, wherein traffic over a channel in a first BSS collides with traffic over the channel in a second BSS. Devices within the first BSS may be hidden and not otherwise known or detected within the second BSS. The presence of hidden nodes or STAs within the range of a BSS can lead to collisions within the BSS.

With the increasing number of wireless devices and networks, there are more overlapping networks, and transmissions causing interference to neighbouring networks. There is a demand to further develop and improve technologies facilitating channel access for multi-link devices.

### SUMMARY

Some aspects of the invention are defined by the features of the independent claims. Some specific embodiments are defined in the dependent claims.

According to a first aspect, there is provided a method, comprising: occupying a first channel for data transmission between a first multi-link device (MLD) and a second MLD for a first channel occupation period, transmitting a measurement request to a subset of MLDs to perform channel measurements on at least two channels during the first channel occupation period, transmitting at least one data message to the second MLD during the first channel occupation period, receiving, after transmission of the at least one data message, at least one channel status report from at least one MLD of the subset of MLDs during the first channel occupation period, wherein the at least one channel status report comprises channel status information of the at least two channels, and selecting a channel, among the at least two channels, for data transmission between the first MLD and a MLD for a second channel occupation period, wherein the selection is based at least partly on the at least one channel status report.

According to a second aspect, there is provided a method, comprising: receiving, from a first MLD, a measurement request to perform channel measurements on at least two channels during a first channel occupation period reserved for communication between the first MLD and a second MLD, performing channel measurements during the first channel occupation period in response to the measurement request, and transmitting, to the first MLD during the first channel occupation period, a channel status report comprising channel status information based on the channel measurements.

According to a third aspect, there is provided a method, comprising: receiving, from a first MLD, a measurement request to perform channel measurements on at least two channels during a first channel occupation period, receiving at least one data message from the first MLD during the first channel occupation period, performing channel measurements during the first channel occupation period in response to the measurement request, and transmitting, to the first MLD during the first channel occupation period and after receiving the at least one data message, a channel status report, comprising channel status information based on the channel measurements.

There is also provided an apparatus comprising at least one processor, at least one memory including computer program code, the at least one memory and the computer program code being configured to, with the at least one processor, cause the apparatus at least to carry out features in accordance with the first aspect, the second aspect, and/or the third aspect, or any embodiment thereof.

There is further provided an apparatus, comprising means configured for causing the apparatus at least to perform the method of the first aspect, the second aspect, and/or the third aspect, or any embodiment thereof. The apparatus may be or comprise the first MLD (and perform the method of the first aspect), the second MLD (and perform the method of the third aspect), and/or the third MLD (and perform the method of the first aspect), or be configured to control features of such MLD. The means may comprise at least one processor, and at least one memory including computer program code, the at least one memory and the computer program code being configured to, with the at least one processor, cause the performance of the apparatus.

According to still further aspects, there is provided a computer program and a computer-readable medium, or a non-transitory computer-readable medium, comprising code configured, when executed in a data processing apparatus, to carry out features in accordance with the first aspect, the second aspect, and/or the third aspect, or an embodiment thereof.

### BRIEF DESCRIPTION OF THE DRAWINGS

FIG. 1 illustrates a wireless communication scenario;

FIGS. 2a and 2b illustrate example protocol stacks of a multi-link device;

FIGS. 3, 4 and 5 illustrate methods in accordance with at least some embodiments;

FIG. 6 is a signalling example in accordance with at least some embodiments;

FIG. 7 illustrates a channel access example;

FIGS. 8 and 9 are signalling example in accordance with at least some embodiments; and

FIG. 10 illustrates an example apparatus capable of supporting at least some embodiments.

### EMBODIMENTS

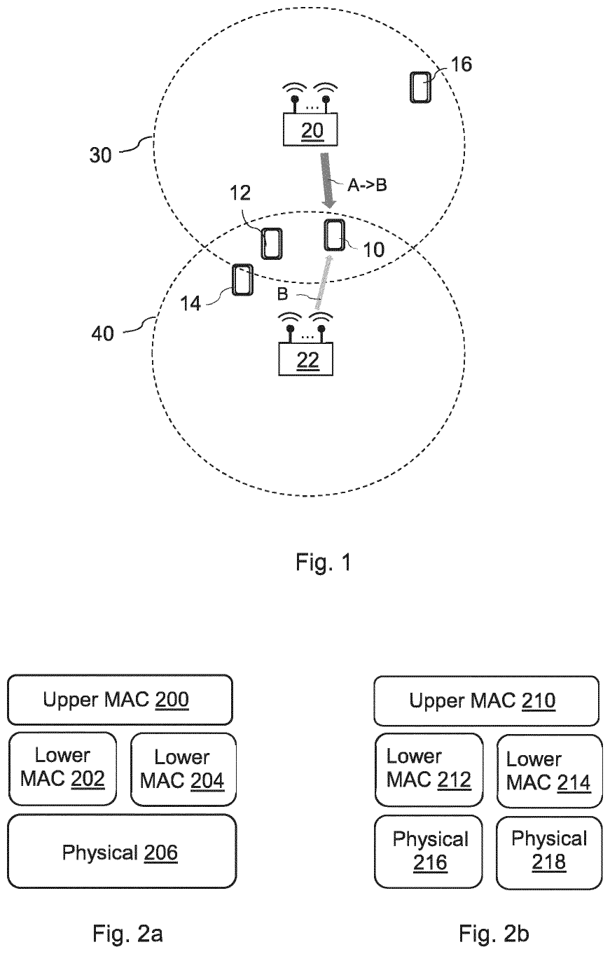

FIG. 1 illustrates a simplified wireless communications and network example. A wireless communications device, in the present example user equipment (UE) 10 may be in a cell or coverage area 30 of another device 20, which may be a wireless radio or access network node, hereafter referred to as AN, such as a NodeB, an evolved NodeB (eNB), a Next Generation (NG) NodeB (gNB), a distributed unit of Integrated Access and Backhaul (IAB) node, a base station, an access point, or other suitable wireless/radio access network device or system. The term base station may refer to any one of NodeB, eNB, gNB, or other base station type. FIG. 1 also illustrates another AN 22 with coverage area 40, UEs 12, 14, and 16.

The UE 10, 12, 16 may be attached, connected or associated to the AN 20 for wireless communications. The air interface between UE and AN may be configured in accordance with a Radio Access Technology, RAT, which both the UE and the AN are configured to support. Examples of cellular RATs include Long Term Evolution, LTE, New Radio, NR, which is also known as fifth generation, 5G, and MulteFire. On the other hand, examples of non-cellular RATs and networks include IEEE 802.11 based networks, which may also be referred to as Wi-Fi, or WLAN as below. Principles of the present disclosure are not limited to a specific RAT though. For example, in the context of NR, AN 20 may be a gNB, while in the context of WLAN, AN 20 may be an access point and the UE a non-access point station (STA).

The AN 20 may be connected, directly or via at least one intermediate node, with another network, a network management system or a core network (not shown), such as a Next Generation core network, Evolved Packet Core (EPC), or other network management element. The core network may comprise a set of network functions. A network function may refer to an operational and/or physical entity. The network function may be a specific network node or element, or a specific function or set of functions carried out by one or more entities, such as virtual network elements. For example, a Third Generation Partnership Project (3GPP) 5G core network comprises Access and Mobility Management Function (AMF) which may be configured to terminate RAN control plane (N2) interface and perform registration management, connection management, reachability management, mobility management, access authentication, access authorization, Security Anchor Functionality (SEAF), Security Context Management (SCM), and support for interface for non-3GPP access.

The AN 20 may be connected with at least one other AN (e.g. AN 22) via an inter-AN/base station interface, particularly for supporting mobility of the UE 10 or for backhaul connection, e.g. by 3GPP X2 or similar NG interface. A gNB may consist of a gNB-Control Unit (CU) and one or more gNB-Distributed Units (DUs), and the interface between gNB-CU and gNB-DU is called F1. One gNB-DU may support one or more cells (sector).

The UE 10, 12, 14, 16 may be referred to as a user device or wireless terminal in general. Hence, without limiting to 3GPP User Equipment, the term user equipment is to be understood broadly to cover various mobile/wireless terminal devices, mobile stations and user devices for user communication and/or machine to machine type communication. The UE 10 may be or be comprised by, for example, a smartphone, a cellular phone, a Machine-to-Machine, M2M, node, machine-type communications node, an Internet of Things, IoT, node, a car telemetry unit, a laptop computer, a tablet computer or, indeed, another kind of suitable user device or mobile station, i.e., a terminal. In some further example embodiments, the first device or UE 10 may be a station of a WLAN or a mobile termination (MT) part of an IAB (relay) node. At least some of the devices of FIG. 1 may be multi-antenna devices and comprise an antenna panel or array for beam-based transmission and reception. The devices may thus be configured to utilize their spatial degrees of freedom for beamforming their transmitted signals and/or placing nulls towards coexisting devices.

Listen-before-talk (LBT) is a mechanism that allows devices and systems to share an unlicensed band while maintaining the performance of each individual system and device. LBT comprises channel sensing for determining whether a channel is occupied, that is, used by another device or vacant. The channel sensing may comprise measurement or measurements of energy on the channel and comparison of the measured energy against a threshold, for example.

There may be wireless communication networks coexisting in the same unlicensed band, which may be of different RATs. An example of a multisystem or multi-RAT coexistence includes IEEE 802.11 and 3GPP 5G NR based networks coexisting on an unlicensed band.

One of the main building blocks in unlicensed operation is a shared channel occupancy time (COT) acquired by a transmitter. In a shared COT an initiating device, such as the AN 20, reserves the wireless medium after a successful LBT for a transmission burst or a sequence of transmission bursts. The wireless medium may comprise certain frequency domain allocation, such as a frequency domain defined for 5G NR operation and/or for WLAN operation. The wireless medium may comprise a set of channels for wireless communications, such as one or more channels defined for 5G NR communication and/or channels defined for WLAN communication. The channels may be frequency channels. The LBT may be performed separately for each of the channels (or it may be possible to carry out LBT jointly for a plurality of channels). For example, 3GPP New Radio Unlicensed (NR-U) at 5 GHz operates with 20 MHz channels. At 60 GHz, the 3GPP NR-U channelization is based on 2.16 GHz bandwidth. On the other hand, in IEEE 802.11 based networks channelization at 2.4 GHz, 5 GHz and 6 GHz bands is based on 20 MHz primary and secondary channels.

In case of 802.11 based networks, carrier sensing (CS) is applied for determining if WLAN medium is idle or not, and there are both physical and virtual CS functions in WLAN devices for this purpose. The physical CS is implemented with clear channel assessment CCA which includes preamble detection and energy detection functions. Preamble detection refers generally to ability of the receiver to detect and decode WLAN signal preamble. Network allocation vector (NAV) is a virtual carrier sensing mechanism that provides means for channel allocation over periods longer than single physical transmissions. A device that has gained a transmission opportunity (TXOP), may send a frame defining a reservation period for channel access. Wireless devices listening to the wireless medium read this information and back off accordingly, refraining contenting on the channel for the duration of the reservation period. The reservation period or TXOP is an example of the COT or channel occupation period.

In some legacy devices, a single protocol stack is supported where there is a single protocol entity on a physical layer and on upper and lower medium access control (MAC) layers. The physical layer may handle radio frequency and baseband signal processing tasks in the transmission and reception. The physical layer may also run the CCA and in some devices it may be able to do it for multiple channels concurrently even if it may not be able to concurrently receive/transmit frames in different channels. The MAC layer may be responsible for channel contention, based on input from the physical layer and specifically from the CCA, in some embodiments by the lower MAC layer. The MAC layer may be responsible of the association and authentication procedures, in some embodiments by the upper MAC layer, for example. In other legacy devices, multiple MAC layers and multiple physical layers may be provided but the number of MAC layers is equal to the number of physical layers. Such devices may support operation multiple channels with the condition that the channel contention is performed only on the primary channel Upon successful channel contention on the primary channel, the device may transmit a frame on the primary channel and, further, on one or more secondary channels. The CCA procedure may be executed on the secondary channel(s) to ensure that they are also free for transmission.

A multi-link device (MLD) is a device capable of operating dynamically on multiple links and switch between associated channels. The MLD may be capable of operating on two or more links simultaneously. The links may be at different frequency bands, such as 2.4 GHz and 5 GHz bands reserved for unlicensed operation.

With the development of the 802.11 networks, a multi-link capability has been proposed also for 802.11 based systems. The IEEE 802.11be task group, which constitutes the basis of future Wi-Fi 7 devices, is currently considering a multi-link feature that allows devices to dynamically operate on several channels/bands simultaneously. With multi-link capability, each packet could be delivered through any of the channels/links. Main motivation for multi-link features includes: increased peak throughput if multiple channels/links are used simultaneously, and decreased channel access delay, as devices can simultaneously contend on multiple channels/links and select the first one available for data transmission. Providing latency and reliability guarantees can enable a number of use cases, including the deployment of industrial private networks in the unlicensed spectrum and augmented/virtual reality applications.

FIG. 2a illustrates an example protocol stack for an MLD, which comprises a single upper MAC layer 200, multiple lower MAC layers 202, 204, and a single physical layer 206 that serves the multiple lower MAC layers.

FIG. 2b illustrates an example protocol stack for an MLD, which supports a single upper MAC layer 210, multiple lower MAC layers 212, 214, and a physical layer 216, 218 per lower MAC layer 212, 214. A set of channels (not illustrated), such as NR-U or 802.11 channels, is available for each physical layer 206, 216, 218.

For example, UEs 10, 12 and AN 20 may be MLDs and support the protocol stack of FIG. 2a or 2b. The multiple lower protocol layers (per upper MAC layer 200, 210) enable the MLD to contend, e.g. within same 802.11 association, simultaneously and/or independently on multiple channels and to transmit in parallel and/or independently on the multiple channels (depending on the support available by the physical layer). Accordingly, the single association may be referred to as a multi-link association enabled by the multiple physical layers (and multiple lower MAC layers) per upper MAC layer. This distinguishes from those legacy devices that have multiple physical layers and multiple lower MAC layers but only single physical layer and a single lower MAC layer per upper MAC layer. The multi-link capability also enables a plurality of associations between lower MAC layers within a single association between upper MAC layers of wireless devices.

Depending on the number of physical layers, the channels of the multi-link association may be on different frequency bands close to or distant from one another. The distant may be understood as so separated that it may not feasible to transmit or receive on the channels at the same time without using a dedicated radio front end (physical layer) for each channel. For example, an MLD supporting multiple physical layers 216, 218 may be capable of transmitting or receiving a frame concurrently on channels of multiple distant frequency bands. In the context of 802.11 systems, one of the channels may include a channel on a 2.4 GHz band while another one of the channels may include a channel on a 5 GHz band. Other systems may employ other frequency bands.

However, the channels may be provided on the same frequency band as well. In this case, an MLD having a single physical layer 206 serving multiple lower MAC layers may be capable of transmitting or receiving a frame concurrently on multiple channels of a single frequency band, e.g. the 2.4 GHz band or 5 GHz band. These embodiments alleviate the channel access in the sense that the MLD is not necessarily limited by the congestion on one of the channels or bands of the wireless network, e.g. the primary channel. When the channels are on the same frequency band, device implementations may cause some restrictions on capabilities of transmitting simultaneously over multiple links. The devices may have capability of indicating such restrictions to other devices, e.g. via one or more information elements in data frames and/or management frames.

At least some of multi-link capable wireless devices may be designed as low-cost devices with a limited signal processing capacity. While such devices may be capable of transmitting or receiving concurrently on multiple channels and over multiple links, the devices may have limited capability of concurrently processing two frames received over two different links. Such MLD may be capable of sensing two channels concurrently but not decoding concurrently multiple frames received on different channels. Such a situation may arise from the design of the device, e.g. the device may be provided with such a low signal processing capacity that it is incapable of processing two (or more) received frames concurrently. However, such a situation may arise when processing resources of the device are temporarily occupied for another task. The device may have sufficient processing capacity to process the two (or more) frames concurrently but the capacity is temporarily not available. Further scenarios where the limited processing capacity limits the concurrent processing of two (or more) frames received via different links can be envisaged.

As further illustrated in FIG. 1, AN 20 may first communicate with UE 10 over channel A. AN 20 may then continue to communicate, e.g. transfer further frame(s) over channel B (A->B) without transferring all the BSS operations from channel A to channel B as in legacy channel switch cases. However, AN 22 may be communicating with UE 14 over channel B, causing interference also to the UE 10 after transmission to the channel B. Since AN 22 is outside coverage area 30 of the AN 20, AN 20 does not detect AN 22 when performing LBT in link B.

The presence of hidden nodes may cause substantial delays and affect reliability. In this context, multi-link operation can introduce some robustness against interference, though it cannot help to solve the hidden node problem. This is because MLDs that can dynamically select one or more links (AN 20 in FIG. 1) for subsequent transmission may sense the medium as free and perform an erroneous link selection, i.e., some associated devices (UE 10) may not be able to receive/transmit data.

The presence of hidden nodes may prevent the practical implementation of multi-link solutions targeted at providing a certain level of throughput, but especially latency and reliability, in unlicensed bands. An initiating MLD may be not interested in or capable of simultaneously occupying the entire available bandwidth for active transmission/reception and dynamically switches between links. Thus, the initiating MLD might want to quickly select and use a second part of the bandwidth for subsequent transmissions/receptions in case, e.g., the first part of the bandwidth is occupied or in backoff.

There are now provided improvements facilitating to ensure that an MLD selects a channel and link that is idle and ready to be accessed by devices involved in the communication.

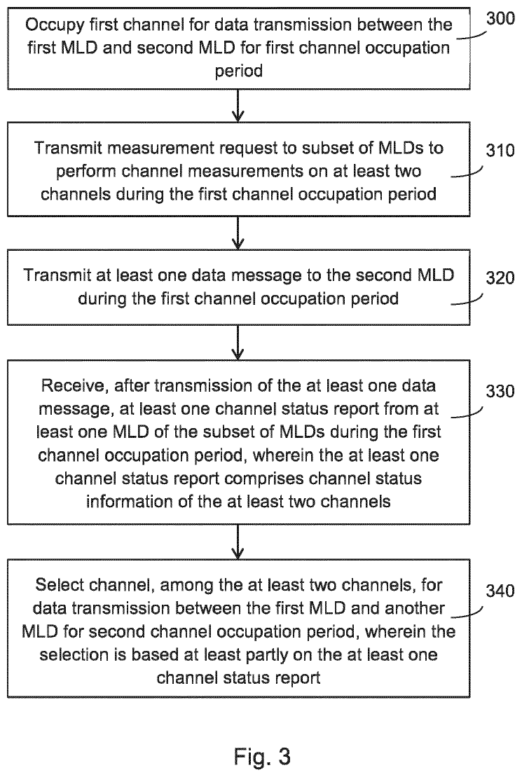

FIG. 3 illustrates a method for arranging channel access, particularly for selecting a method for directional channel occupancy detection, which may also be referred to as a channel sensing type or method. The method may be performed by an apparatus, which may be a wireless communications device or a controller thereof. The method may be performed by a first MLD, which may be a (communication) initiating device (as also cited in the subsequent embodiments), such as the AN 20, communicating with a second (responding) MLD, such as the UE 10.

The method comprises occupying 300 a first channel for data transmission between the first MLD and a second MLD for a first channel occupation period. A measurement request is transmitted 310 to a subset of MLDs to perform channel measurements on at least two channels during the first channel occupation period, which may also be referred to as channel occupancy time (COT), as below. At least one data message is transmitted 320 to the second MLD during the first COT. At least one channel status report is received 330 from at least one MLD of the subset of MLDs during the first COT, after transmission of the at least one data message. The channel status report(s) may comprise channel status information of the at least two channels. A channel is selected 340, among the at least two channels, for data transmission between the first MLD and a MLD for a second COT. The selection is based at least partly on the received channel status report(s) and may involve selection of link to be applied by the first MLD during the second COT.

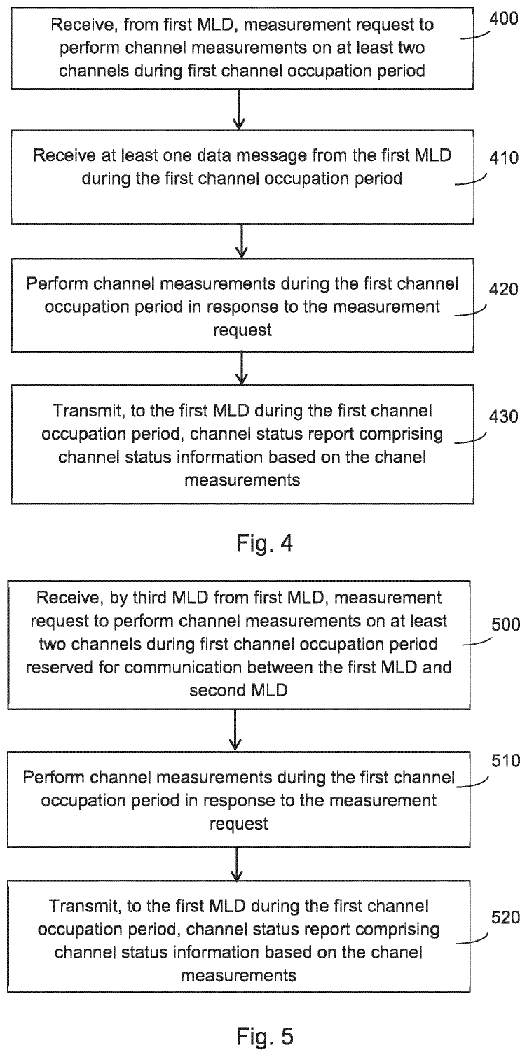

FIG. 4 illustrates a method for facilitating channel access. The method may be performed by an apparatus, which may be a wireless communications device or a controller thereof. The method may be performed by a second MLD, which may be a responding device, such as the UE 10, communicating with a first MLD, which may be a communication initiating device performing the method of FIG. 3, such as the AN 20.

The method comprises receiving 400, from a first MLD, a measurement request to perform channel measurements on at least two channels during a first COT reserved between the first MLD and a second MLD. The measurement request may be addressed to a subset of MLDs. At least one data message is received 410 from the first MLD during the first COT Channel measurements are performed 420 during the first COT in response to the measurement request. A channel status report comprising channel status information based on the channel measurements is transmitted 430 to the first MLD during the first COT. The channel status report may be for selecting a channel among the at least two channels, for data transmission between the first MLD and a MLD for a second COT.

FIG. 5 illustrates a method for facilitating channel access. The method may be performed by an apparatus, which may be a wireless communications device or a controller thereof. The method may be performed by a third MLD, which may be a responding device, such as the UE 10, responding to communication of communication initiating first MLD, such as the AN 20.

The method comprises receiving 500, by a third MLD from a first MLD, a measurement request to perform channel measurements on at least two channels during a first COT reserved for communication between the first MLD and a second MLD. The measurement request may be addressed to a subset of MLDs. The first COT, is for transmitting at least one data message from the first MLD to the second MLD Channel measurements are performed 510 during the first COT in response to the measurement request. A channel status report comprising channel status information based on the channel measurements is transmitted 520 to the first MLD during the first COT. The channel status report may be for selecting (340) a channel among the at least two channels, for data transmission between the first MLD and a MLD for a second COT.

It is to be noted that an end-user device or an infrastructure network device, or a component thereof, may be configured to selectively operate as the initiating or responding MLD, and to perform one of the methods of FIGS. 3 to 5 according to currently adopted role of initiating (FIG. 3) or responding device (FIG. 4 or 5). It will be appreciated that there may be various further features and blocks in connection with the methods of FIGS. 3 to 5. Some example embodiments are illustrated below.

The measurement request may be transmitted before occupying 300 the first channel for transmission, i.e. before the first COT. Thus, block 310 may be performed before block 300. In another embodiment, the measurement request is transmitted after block 300. In some embodiments, the measurement request is transmitted during the first COT. The measurement request may be transmitted in the beginning of the first COT, e.g. in a first frame that starts the first COT. The measurement request may be embedded in or piggybacked to a data frame transmitted during the first COT.

The measurement request in block 310, 400, 500 may be addressed to and may identify MLD(s) of the sub-set. In some embodiments the subset may comprise plurality of MLDs and in other embodiments the subset may consist of a single MLD. The measurement request may be transmitted 320 to MLD(s) supporting multi-link measurement capability. Such capability may be reported by MLDs, on the basis of which the first MLD may select MLDs for which the measurement request is transmitted 310. MLD selection may be an additional block preceding block 310. MLDs may be selected into the sub-set based on their properties or requirements, in an embodiment based on latency and/or reliability requirements. Thus, MLDs with strict latency and/or reliability requirements may be selected to the sub-set. However, other criteria may be instead or additionally applied for selecting the MLDs for channel measurements. For example, in the scenario of FIG. 1, AN 20 may select UEs 10 and 12 to perform the measurements, but not UE 16.

In another embodiment, the measurement request does not specifically identify the MLD(s), but is transmitted e.g. as a broadcast type of message in associated radio access network. However, the measurement request may apply only to devices capable of multi-link capabilities. The MLDs may belong to same wireless access network, such as 802.11 based network or 3GPP based NR-U network. The second MLD and the at least one/third MLD may be associated to the first MLD. The (initiating) first MLD may specify channels or links that the (responding) MLD(s) should report about, and indicate these specified channels or links in the measurement request. In an example, the first MLD may request the responding MLDs to perform measurements only at channels which the first MLD perceives as available, hence enabling to further reduce use of resources for measurement.

Upon reception of the measurement request, which may request to provide multi-link medium status report for hidden node prevention, the MLDs may in block 420 and 510 perform channel measurements to determine medium status of a set of channels and links where those devices may be subsequently served. The MLDs may include information indicative of the medium status (as the channel status report) in a transmission that precedes the start of a data transmission/reception during the second COT, which may then be performed in a different channel and link.

The first MLD may dedicate time and frequency resources during the first COT for reception of channel status reports. Such resources may be indicated to the subset of the MLDs in the measurement request. The second/third MLD then adapts the transmission of the channel status report in block 430/520 in accordance with the received resource information. There can be multiple downlink and uplink portions in a COT, uplink referring herein to transmission direction from other (second/third) MLDs to the first MLD (e.g. UE 10 or AP 20). A specific uplink transmission where the channel status reports should be provided may be identified as per scheduling indications of the first MLD in the measurement request. Preferably the last uplink transmission is controlled to be used for transmitting the channel status report. For example, in case of communication between (MLD) UEs and a gNB (which takes the role of the first MLD/initiating device), the gNB may reserve resources that the UEs should use to convey their channel status reports.

One or more channel status reports may thus be received (also) in block 330 from (third) MLD(s) not being receiver of the data message(s) 310 transmitted by the first MLD during the first COT. For example, a channel status report from UE 12 may be relevant for avoiding selecting channel B used by AN 22 towards UE 14.

The first MLD may perform an LBT procedure and channel measurements, which may be an additional block before block 340. The first MLD may then select in block 340 the channel(s) and link for subsequent transmission/reception for the second COT further on the basis of medium statuses based on its own measurements performed on the channels. A (sub)set of unoccupied channels (among channels for which measurements results are available) may be determined on the basis of all available channel measurement information, and the channel and associated link may be selected among the unoccupied channels in the set.

The first MLD may then after block 340 transmit, during the second COT after the first COT, (further) data message(s) to the second MLD, the third MLD, or another (fourth) MLD at a channel selected based on the channel status report of block 330, 430, 520. The second/third/fourth MLD thus receives (after block 430/520) the data message(s) from the first MLD at the channel (selected by the first MLD) based on the channel status report.

The present features facilitate improved channel state awareness for the first MLD selecting channel and link for subsequent data transmission, enabling to further mitigate or avoid the hidden node problem. The first MLD may obtain channel state information from other (third) MLDs during the first COT with the second MLD, and thus have relevant channel status as seen by the third MLD readily available for the second COT for communicating with such third MLD. The first MLD has up-to-date channel status knowledge already available when the first COT ends, enabling to avoid delay caused by channel state measurements after the first COT or at the beginning of the second COT. The present features enable to identify and leverage availability of MLD-specific medium status information, which may be applied also for addressing the subsequent data transmission during the second COT.

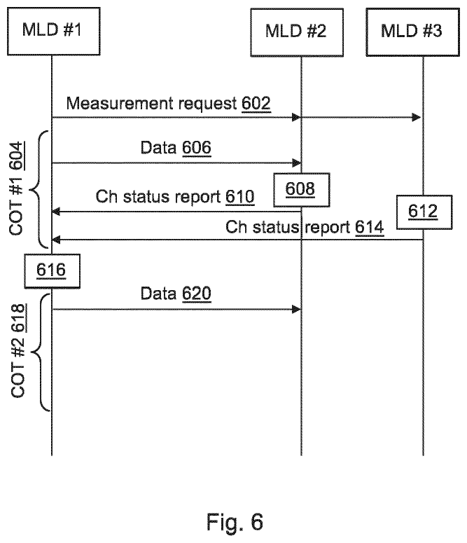

FIG. 6 illustrates signaling between the first MLD (MLD #1), the second MLD (MLD #2), and the third MLD (MLD #3), performing the method of FIG. 3, 4, or 5, respectively.

MLD #1 may activate a multi-link hidden node prevention mode and transmit measurement request(s) 602 to a sub-set of MLDs, in the present example MLD #2 and MLD #3. For example, a hidden node prevention mode engine may set a hidden node prevention model flag on as an input, and causing the MLD #1 to enter block 602. The measurement request may be a request to activate multi-link medium status report mode in the receiving MLD. It is to be appreciated that the measurement request 602 may be transmitted by a single transmission, or by separate messages to the MLDs #2 and #3.

A channel access engine of MLD #1 obtains a (first) COT, COT #1 604, which in the present example begins after the transmission of the measurement request 602. In another embodiment, the measurement request is transmitted during the COT #1. MLD #1 communicates with the MLD #2 during the COT #1, and may transmit data frame(s) 606 to the MLD #2.

The measurement request 602 causes the MLD #2 and MLD #3 to perform channel measurements 608, 612 on at least two channels during the COT #1 604. In an embodiment, in response to the measurement request 602, MLD #2 and #3 enter the multi-link hidden node prevention mode, controlling the measurements. MLD #1 may enforce that an uplink transmission is performed at latter half of COT #1, preferably near end of COT #1, for transmitting channel status reports comprising channel measurement information based on the channel measurements.

The channel measurement and/or reporting timing of MLDs #2 and #3 may be controlled based on timing information in the measurement request 602 and/or by configuration of the (multi-link hidden node prevention) mode activated by the measurement request. The MLDs #2 and #3 may be caused or configured to check if last uplink transmission is to be performed, and perform the channel measurements immediately before initiating the last uplink transmission, in which the channel status report is included. For example, the MLDs #2 and #3 may be controlled to perform the measurements 608, 612 on configured set of channels during DL slots or symbols of the ongoing COT #1 604.

The MLDs #2 and #3 transmit their respective channel status reports 610, 614 to MLD #1 during the COT #1. MLD #1 selects 616 a channel, amongst at least the channels for which measurement reports 610, 614 have been received, for communication during a second COT #2 618. On the basis of a successful LBT procedure on available channel(s), i.e. upon detecting the wireless medium to be unoccupied, the MLD #1 may thus reserve the wireless medium for the subsequent transmission. The COT #2 and the selected channel may be used by the MLD #1 for communicating with the MLD #2, MLD #3, or another MLD, which has or has not been involved in channel measurement reporting during the COT #1 604. The example of FIG. 6 illustrates transmission of a data frame 620 to the MLD #2. In another example embodiment, MLD #1 may select another receiving MLD, e.g. MLD #3, and/or another channel based on at least partly on one or more of the received channel status reports for transmitting a data frame during COT #2.

The MLD #1 may thus dynamically change from one channel to another, and from one link to another, on the basis of channel measurements performed by a plurality of measurements on a plurality of channels. Since the channel measurements are performed already during ongoing COT #1, the MLD #2 may instantly reserve the COT #2 on the selected channel after end of the COT #1.

The channel and link may be selected 340, 616 randomly among the set of channels detected as unoccupied based on the received channel status report(s) and measurement information by the first MLD #1. The first MLD may prioritize channel status reports from one or more responding MLDs, such as the second MLD #2, performing the method of FIG. 4. In an example embodiment, the first MLD may prioritize channel status reports from MLD(s) on the basis of their latency and/or reliability requirements. Reports from MLDs with stricter latency or reliability requirements may thus be prioritized. Such prioritization may be applied e.g. if there are no channels and links detected as unoccupied both for the first MLD and the responding MLD(s).

The MLDs may perform LBT procedures according to the applied RAT. Some examples of available channel access schemes comprise: a) immediate transmission after a short switching gap from reception to transmission, b) LBT without random back-off, c) LBT with random back-off with contention window of fixed size, and d) LBT with random back-off with contention window of variable size.

The measurement request 310, 400, 500, 602, the channel status report(s) 330, 430, 520, 610, 614, and the data transmission (during the first COT and/or the second COT) 320, 340, 410, 606, 620 use same radio technology. That is, the respective transmission/reception events may be performed by a single RAT unit of the apparatus performing the method of FIG. 3, 4 or 5. The responding MLD may be capable of simultaneously receiving/transmitting data in one channel/link, and sensing the medium in different channels/links (e.g., through energy detection) utilizing the same RAT.

In some embodiments, the wireless access network is NR-U or 802.11 based network, and the MLDs comprise a NR-U transceiver and/or a WLAN transceiver. The first MLD may be (configured to operate as) a gNB and/or an access point (AP), and the other MLDs #2, #3 may be (configured to operate as) a non-AP station and/or a user equipment. For example, the AN 20 is performing the method of FIG. 3 and is configured to operate as a gNB comprising an NR-U transceiver, i.e. a communications unit configured to operate in unlicensed spectrum on the basis of 3GPP NR based access. The AN 20 may (also) be configured to operate as a WLAN AP.

In another example embodiment, the first MLD is a non-AP station or a user equipment which may communicate with an AP or a gNB, or with another non-AP station and/or a user equipment (which may operate as the second or the third MLD). Some further example embodiments for 802.11 based WLAN and 3GPP 5G based systems are illustrated below.

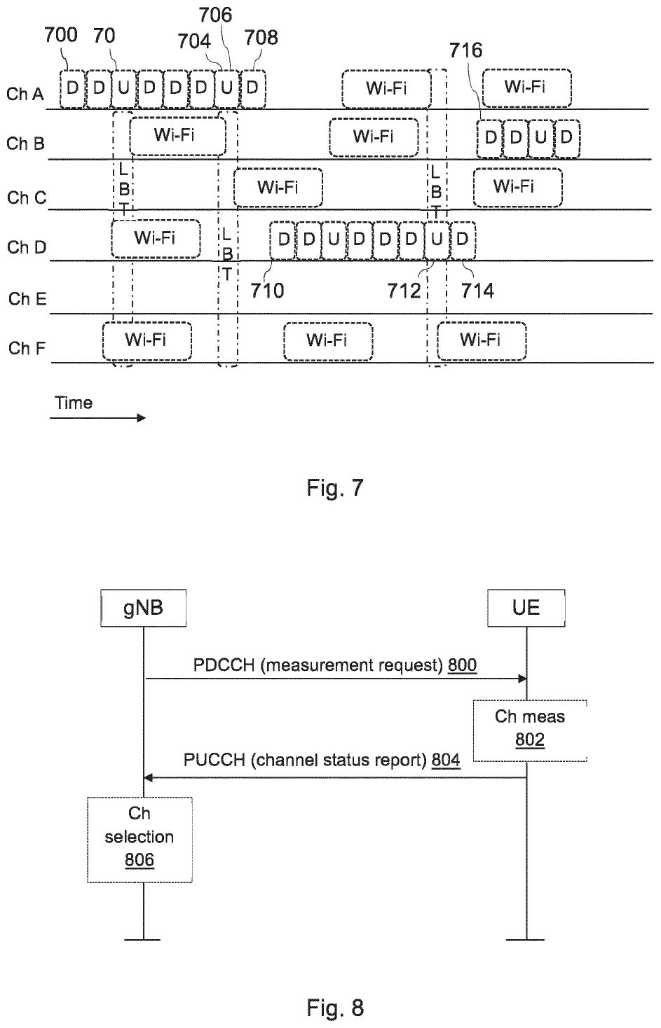

There may be coexisting wireless communication networks coexisting in the same unlicensed band, which may be of different RATs. FIG. 7 illustrates an example, in which a WLAN and a cellular network, such as a NR-U network, coexist in the same unlicensed band. Multi-RAT MLDs, i.e. MLDs supporting more than one RAT, may operate at least partially on same channels by different RATs. Various scenarios of coexistence are facilitated, for example, wherein a gNB is neighbour to a WLAN AP. The methods enable benefits also for relay-type network nodes. For example, 3GPP integrated access backhaul (IAB) relays, and WLAN relays/bridges may be configured to apply at least some of the above-illustrated embodiments.

In the example of FIG. 7, an NR-U compliant gNB operates as the first/initiating MLD performing the method of FIG. 3. The multi-link gNB in this example may be capable of operating in 6 channels (which may be at least partially of different links) simultaneously but only transmitting/receiving on a sub-set of the channels at a time. At first downlink (D) transmission 700, the gNB requests channel status feedback by transmitting the measurement request. At time instant 702, channel sensing (LBT) is performed, which may indicate channels B, D, and F being occupied by WLAN traffic. During uplink (U) slot 704, scheduled MLD(s) transmit to the gNB their channel status report(s), indicative of channel status in candidate channels/links (at least some of A-F). The gNB also performs 706 channel sensing in the last uplink slot of the COT in channel A, and selects 708 next channel, D, based on received channel status information and own measurements. The gNB may then instantly obtain subsequent COT for channel D and start transmission 710. Similarly, at last uplink slot, channel status reports are received 712. The gNB detects that channel B is unoccupied and selects 714 channel B for the subsequent transmission 716.

Signaling messages illustrated above may be included in a burst or a frame in accordance with the applied signaling interface between the MLDs. At least some of the above illustrated information may be added in a new information element or added in an existing information element of an applicable message.

There are many options for arranging the transmission of the measurement request and the channel status reports. In some example embodiments, the measurement request is comprised in system information within physical downlink control channel (PDCCH) transmission, in dedicated radio resource control (RRC) signal, or groupcast message. In an example, gNB includes the measurement information in system information block (SIB) of PDCCH transmitted to all devices within coverage of the gNB. The sub-set of MLDs may thus refer to MLDs associated with or in reachable the first MLD. The measurement request message may also convey information on the specific set of channels/links where the configured MLDs should perform measurements.

For example, if the first MLD is a UE, e.g. UE 10, and the destination of the communication is another UE, e.g. UE 12, i.e. there may be a sidelink or device to device (D2D) communication flow), then the measurement request may be transmitted at least to the other UE or group(s) of UEs e.g. by groupcast. The initiating UE 10 may thus reserve resources that the responding MLDs (UEs) should use to convey their channel status reports.

In some embodiments, the channel status report in block/message 330, 430, 520, 610, 614 provided by the responding devices may comprise a binary indication of the channel status, i.e., free or busy. Thus, blocks 420, 510, 608, 612 may comprise performing channel sensing and indicating result of the channel sensing as the channel status information in the channel status report. In another embodiment, the channel status report and the channel status information indicates measured power level per channel. The channel measurements may comprise (and channel status report may indicate) one-time measurements, measurements averaged over a time window, or based on specific measurement samples (i.e., sampled vector). However, it will be appreciated that these represent only some examples of how the measurement information may be included in the channel status reports.

In some embodiments, as already illustrated, presently disclosed features are applied for accessing unlicensed wireless medium by 3GPP 5G system. NR Release 15 defines operation for frequencies up to 52.6 GHz. Unlicensed band access beyond 52.6 GHz, around 60 GHz is also being studied. In an example embodiment, at least some of 5G channel access schemes for LBT types or categories are applied, as such or as modified. Such access schemes may include one or more of category 1 immediate transmission and two or more further LBT categories, which may be defined in channel access schemes of 3GPP TR 38.889.

In an example embodiment, with reference to simplified FIG. 8, gNB transmits the measurement request (which may be an activation message for the multi-link hidden node prevention mode) at the beginning of each COT/TXOP as a or as a part of a PDCCH message 800. The measurement request may be included in a group-common PDCCH transmission, e.g. by applying downlink control information (DCI) format 2_0, or another appropriate format. A DCI field indicative of the measurement request, and potential further parameters thereof (e.g. the channels to be measured), may be included in the PDDCH message 800.

In an example embodiment, the channel status reports are included in physical uplink control channel (PUCCH) signalling from NR-U UE to gNB. Thus, based on channel measurements 802, the UE may transmit PUCCH message comprising the channel status report 804, on the basis of which (and own channel measurements) the gNB selects 806 a channel and link for subsequent data transmission and COT. For example, the channel status report maybe included with other uplink control information, such as channel quality indicator (CQI) and hybrid automatic repeat request (HARQ) ack/nack (A/N) feedback.

IEEE 802.11be (also known as Extremely High Throughput (EHT) Wi-Fi) is an example of 802.11 versions/systems, in which at least some of the above illustrated features may be applied.

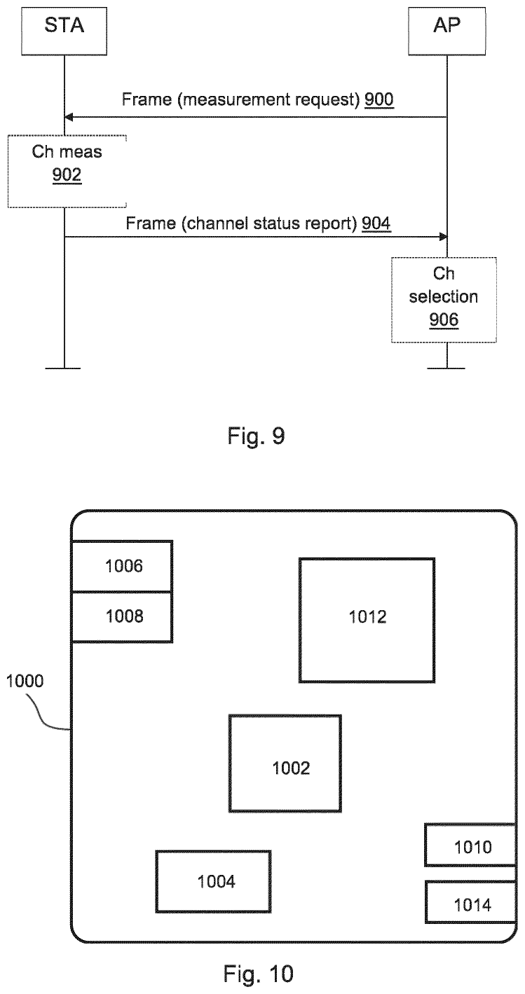

FIG. 9 illustrates a simplified example of an embodiment for a WLAN based system. The AP may transmit the measurement request in an 802.11 management frame 900.

In response to the frame 900, the STA performs channel measurements 902. The STA may then transmit a frame 904 comprising the channel status report during the ongoing TXOP. On the basis of the report (and own channel measurements) the AP selects 906 a WLAN channel and link for subsequent data transmission and TXOP. The change to the new selected channel may be arranged without transferring BSS operations between channels.

In some embodiments, at least some of the transmission and/or reception events of FIG. 3, 4 or 5, or embodiments thereof, are performed by two different RATs.

In an example embodiment, transmission/reception of the measurement request 310, 400, 500, 602 and the channel status report 330, 430, 520, 610, 614 is performed via a first RAT and the channel measurements 420, 510, 608, 612 are performed via a second RAT. This may be beneficial when the responding (second/third) MLD is equipped with multiple RATs (e.g., NR-U and WLAN), communicates with the initiating (first) MLD using the first RAT (e.g., NR-U) not capable of simultaneously transmitting/receiving in one link and sensing the medium in different links, and can utilize the second RAT (e.g., WLAN) for multi-link medium sensing purposes. Thus, upon receiving the measurement request via NR-U interface, WLAN interface is activated (via inter-RAT interface) for multi-channel/link status sensing Channel measurement information is provided from the WLAN interface/unit to the NR-U interface/unit, which transmits the information to the gNB in a channel status report.

In another example embodiment, transmission/reception of the measurement request 310, 400, 500, 602 and the at least one channel status report 330, 430, 520, 610, 614 is performed via a first RAT, such as WLAN, and data transmissions 320, 340, 410, 606, 620 are performed via a second RAT, such as NR-U. The channel measurements 420, 510, 608, 612 may be performed via the first RAT or the second RAT. Thus, the first MLD may, upon receiving the measurement reports via the first RAT and detecting or selecting available channel and link, inform or trigger the second RAT (via inter-RAT) interface of the available channel and link. The second RAT may, in response to the received information, thus reserve the available channel and start data transmission. The first RAT may thus be used for enabling the hidden node prevention mode, and the second RAT for data transmission/reception. Among other potential benefits, this allows reducing the communication overhead in the wireless interface utilized for data transmission/reception.

In an embodiment, according to dynamic multi-link operations discussed in one or more embodiments above, the change to the new selected channel does not comprise transferring channel switch announcement frame/element or extended channel switch announcement frame. In an embodiment, no channel switch frame is transferred before initiating data transfer on the new selected channel.

In an embodiment, the MLD is a device that has more than one affiliated STA and has one MAC SAP to logical link control (LLC), which includes one MAC data service. In such embodiment, the first device/MLD and/or the second device/MLD may comprise plurality of affiliated STAs. In an embodiment, a first affiliated STA of an MLD may operate on a first channel of the multi-link association and a second affiliated STA of the MLD may operate on a second channel of the multi-link association, and the change to the new selected channel may comprise selecting the second affiliated STA for transferring a further data frame.

While some embodiments have been described in the context of 5G NR-U and WLAN/IEEE 802.11 based systems, it should be appreciated that these or other embodiments of the invention may be applicable in connection with other technologies configured to operate on licensed or non-licensed band, such as with wireless devices operating according to other local-connectivity technologies, 6G cellular systems, or other existing or future technologies facilitating dynamic multi-link operations.

An electronic device comprising electronic circuitries may be an apparatus for realizing at least some embodiments of the present invention. The apparatus may be or may be comprised in a computer, a laptop, a tablet computer, a cellular phone, a machine to machine (M2M) device (e.g. an IoT sensor device), a base station, an access point or node device or any other apparatus provided with radio communication capability. In another embodiment, the apparatus carrying out the above-described functionalities is comprised in such a device, e.g. the apparatus may comprise a circuitry, such as a chip, a chipset, a microcontroller, or a combination of such circuitries in any one of the above-described devices.

The apparatus may comprise a communication circuitry providing the apparatus with capability of communicating in at least one wireless network. The communication circuitry may employ a radio interface providing the apparatus with radio communication capability. The radio interface may comprise a radio modem RF circuitries providing at least a part of the above-described physical layer(s) of the wireless device. The radio interface may be comprised in the apparatus in the embodiments where the apparatus is the wireless device. In other embodiments where the apparatus is a chipset for the wireless device, the radio interface may be external to the apparatus.

The radio interface may support transmission and reception according to the principles described above. The RF circuitries may comprise radio frequency converters and components such as an amplifier, filter, and one or more antennas. The radio modem may comprise baseband signal processing circuitries such as (de)modulator and encoder/decoder circuitries. The communication circuitry may carry out at least some of the functions of the MAC layer(s) described above. In embodiments where the apparatus employs multiple physical layer entities, the radio modem and the RF circuitries may employ a separate transmitter and receiver branch for each of the multiple links supported by the apparatus. The radio modem and the RF circuitries may include a dedicated circuitry for the physical layer and another dedicated circuitry for the physical layer, although the dedicated circuitries may employ partially the same physical components in the transmission and/or reception. The communication circuitry may comprise multiple channel sensing circuitries, each configured to perform channel sensing on a channel.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

FIG. 10 illustrates an example apparatus capable of supporting at least some embodiments of the present invention. Illustrated is a device 1000, which may comprise a communications device arranged to operate as the first MLD, the second MLD, the third MLD, such as the UE 10, 12 or the AN 20, for example. The device may include one or more controllers configured to carry out operations in accordance with at least some of the embodiments illustrated above, such as some or more of the features illustrated above in connection with FIGS. 3 to 9. The device may be configured to operate as the apparatus configured to carry out the method of FIGS. 3, 4, and/or 5, for example.

Comprised in the device 1000 is a processor 1002, which may comprise, for example, a single- or multi-core processor wherein a single-core processor comprises one processing core and a multi-core processor comprises more than one processing core. The processor 1002 may comprise more than one processor. The processor may comprise at least one application-specific integrated circuit, ASIC. The processor may comprise at least one field-programmable gate array, FPGA. The processor may be means for performing method steps in the device. The processor may be configured, at least in part by computer instructions, to perform actions.

The device 1000 may comprise memory 1004. The memory may comprise random-access memory and/or permanent memory. The memory may comprise at least one RAM chip. The memory may comprise solid-state, magnetic, optical and/or holographic memory, for example. The memory may be at least in part accessible to the processor 1002. The memory may be at least in part comprised in the processor 1002. The memory 1004 may be means for storing information. The memory may comprise computer instructions that the processor is configured to execute. When computer instructions configured to cause the processor to perform certain actions are stored in the memory, and the device in overall is configured to run under the direction of the processor using computer instructions from the memory, the processor and/or its at least one processing core may be considered to be configured to perform said certain actions. The memory may be at least in part comprised in the processor. The memory may be at least in part external to the device 1000 but accessible to the device. For example, control parameters affecting operations related to the obtaining channel and link status information may be stored in one or more portions of the memory and used to control operation of the apparatus. Further, the memory may comprise device-specific cryptographic information, such as secret and public key of the device 1000.

The device 1000 may comprise at least one transmitter 1006 and at least one receiver 1008. The transmitter and the receiver may comprise communication circuitry as above illustrated and be configured to operate in accordance with a wireless, cellular or non-cellular standard, such as wideband code division multiple access, WCDMA, long term evolution, LTE, 5G or other cellular communications systems, and/or a WLAN standard, for example. The device 1000 may comprise a transceiver of another RAT, or a near-field communication, NFC, transceiver 1010. The NFC transceiver may support at least one NFC technology, such as NFC, Bluetooth, Wibree or similar technologies.

The device 1000 may comprise user interface, UI, 1012. The UI may comprise at least one of a display, a keyboard, a touchscreen, a vibrator arranged to signal to a user by causing the device to vibrate, a speaker and a microphone. A user may be able to operate the device via the UI, for example to configure or control the device.

The device 1000 may comprise or be arranged to accept a user identity module or other type of memory module 1014. The user identity module may comprise, for example, a subscriber identity module, SIM, and/or a personal identification IC card installable in the device 1000. The user identity module 1014 may comprise information identifying a subscription of a user of device 1000. The user identity module 1014 may comprise cryptographic information usable to verify the identity of a user of device 1000 and/or to facilitate encryption and decryption of communication effected via the device 1000.

The processor 1002 may be furnished with a transmitter arranged to output information from the processor, via electrical leads internal to the device 1000, to other devices comprised in the device. Such a transmitter may comprise a serial bus transmitter arranged to, for example, output information via at least one electrical lead to memory 1004 for storage therein. Alternatively to a serial bus, the transmitter may comprise a parallel bus transmitter. Likewise the processor may comprise a receiver arranged to receive information in the processor, via electrical leads internal to the device 1000, from other units comprised in the device 1000. Such a receiver may comprise a serial bus receiver arranged to, for example, receive information via at least one electrical lead from the receiver 1008 for processing in the processor. Alternatively to a serial bus, the receiver may comprise a parallel bus receiver.

The device 1000 may comprise further devices not illustrated in FIG. 10. For example, the device may comprise at least one digital camera. Some devices may comprise a back-facing camera and a front-facing camera. The device may comprise a fingerprint sensor arranged to authenticate, at least in part, a user of the device. In some embodiments, the device lacks at least one device described above. For example, some devices may lack the NFC transceiver 1010 and/or the user identity module 1014.

The processor 1002, the memory 1004, the transmitter 1006, the receiver 1008, the NFC transceiver 1010, the UI 1012 and/or the user identity module 1014 may be interconnected by electrical leads internal to the device 1000 in a multitude of different ways. For example, each of the aforementioned devices may be separately connected to a master bus internal to the device, to allow for the devices to exchange information. However, as the skilled person will appreciate, this is only one example and depending on the embodiment various ways of interconnecting at least two of the aforementioned devices may be selected without departing from the scope of the present invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or functional features may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof.

Furthermore, the described features, structures, or characteristics may be combined in any suitable manner in one or more embodiments. In the preceding description, numerous specific details are provided to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

1-39. (canceled)

40. A method, comprising:
occupying a first channel for data transmission between a first multi-link device and a second multi-link device for a first channel occupation period,
transmitting a measurement request to a subset of multi-link devices to perform channel measurements on at least two channels during the first channel occupation period,
transmitting at least one data message to the second multi-link device during the first channel occupation period,
receiving, after transmission of the at least one data message, at least one channel status report from at least one multi-link device of the subset of multi-link devices during the first channel occupation period, wherein the at least one channel status report comprises channel status information of the at least two channels, and
selecting a channel, among the at least two channels, for data transmission between the first multi-link device and a multi-link device for a second channel occupation period, wherein the selection is based at least partly on the at least one channel status report.

41. The method of claim 40, wherein the measurement request is transmitted before said occupying the first channel for data transmission.

42. The method of claim 40, wherein the at least one channel status report is received from a third multi-link device.

43. The method of claim 40, wherein the measurement request, the at least one channel status report, and transmission of the at least one data message use same radio technology.

44. The method of claim 40, wherein transmission of the measurement request and reception of the at least one channel status report is performed via a first radio technology, and transmission of the at least one data message is performed via a second radio technology.

45. The method of claim 40, wherein the channel is selected further on the basis of measurements performed by the first multi-link device.

46. The method of claim 40, wherein the second multi-link device and the at least one multi-link device are associated to the first multi-link device.

47. The method of claim 40, wherein the measurement request is comprised in system information within physical downlink control channel transmission, in a dedicated radio resource control signal, or in a groupcast message.

48. The method of claim 40, wherein the first multi-link device has dedicated time and frequency resources during the first channel occupation period for reception of channel status reports and indicates the resources to the subset of the multi-link devices.

49. A method, comprising:
receiving, from a first multi-link device, a measurement request to perform channel measurements on at least two channels during a first channel occupation period reserved for communication between the first multi-link device and a second multi-link device,
performing channel measurements during the first channel occupation period in response to the measurement request, and
transmitting, to the first multi-link device during the first channel occupation period, a channel status report comprising channel status information based on the channel measurements.

50. The method of claim 49, further comprising: receiving, during a second channel occupation period after the first channel occupation period, at least one data message from the first multi-link device at a channel based on the channel status report.

51. The method of claim 49, wherein the measurement request indicates multi-link devices that should enable multi-link medium status reports for hidden node prevention.

52. An apparatus comprising at least one processor, at least one memory including computer instructions, the at least one memory and the computer instructions being configured to, with the at least one processor, cause the apparatus at least to perform:
occupying a first channel for data transmission between a first multi-link device and a second multi-link device for a first channel occupation period,
transmitting a measurement request to a subset of multi-link devices to perform channel measurements on at least two channels during the first channel occupation period,
transmitting at least one data message to the second multi-link device during the first channel occupation period,
receiving, after transmission of the at least one data message, at least one channel status report from at least one multi-link device of the subset of multi-link devices during the first channel occupation period, wherein the at least one channel status report comprises channel status information of the at least two channels, and
selecting a channel, among the at least two channels, for data transmission between the first multi-link device and a multi-link device for a second channel occupation period, wherein the selection is based at least partly on the at least one channel status report.

53. The apparatus of claim 52, wherein the at least one channel status report is received from a third multi-link device.

54. The apparatus of claim 52, wherein the at least one memory and the computer instructions are configured to, with the at least one processor, cause the apparatus to select the channel further on the basis of measurements performed by the first multi-link device.

55. The apparatus of claim 52, wherein the measurement request is comprised in system information within physical downlink control channel transmission, in a dedicated radio resource control signal, or in a groupcast message.

56. The apparatus of claim 52, wherein the at least one memory and the computer instructions are configured to, with the at least one processor, further cause the apparatus to dedicate time and frequency resources during the first channel occupation period for reception of channel status reports and indicate the resources to the subset of the multi-link devices.

57. An apparatus comprising:
at least one processor, at least one memory including computer instructions, the at least one memory and the computer instructions being configured to, with the at least one processor, cause the apparatus at least to perform:
receiving, from a first multi-link device, a measurement request to perform channel measurements on at least two channels during a first channel occupation period reserved for communication between the first multi-link device and a second multi-link device,
performing channel measurements during the first channel occupation period in response to the measurement request, and
transmitting, to the first multi-link device during the first channel occupation period, a channel status report comprising channel status information based on the channel measurements.

58. The apparatus of claim 57, wherein the at least one memory and the computer instructions are configured to, with the at least one processor, further cause the apparatus to receive, during a second channel occupation period after the first channel occupation period, at least one data message from the first multi-link device at a channel based on the channel status report.

59. A non-transitory computer-readable medium, comprising code for, when executed in an apparatus, causing the apparatus to perform a method in accordance with claim 40.
